(19) United States
(12) Patent Application Publication
(10) Pub. No.: US 2011/0085663 A1
(43) Pub. Date: Apr. 14, 2011

(54) METHOD FOR THE ACCESS-RELATED OR COMMUNICATION-RELATED RANDOM ENCRYPTION AND DECRYPTION OF DATA

(75) Inventors: Werner Rozek, Floh-Seligenthal (DE); Thomas Rozek, Floh-Seligenthal (DE); Jan Rozek, Floh-Seligenthal (DE)

(73) Assignee: FACHHOCHSCHULE SCHMALKALDEN, Schmalkalden (DE)

(21) Appl. No.: 12/918,502

(22) PCT Filed: Nov. 17, 2008
(86) PCT No.: PCT/EP2008/065655

§ 371 Date: Nov. 11, 2010

(30) Foreign Application Priority Data
Feb. 22, 2008 (DE) 10 2008 010 789.1

(51) Int. Cl. H04L 9/00

(52) U.S. Cl. 380/255

(57) ABSTRACT

A method is provided for encryption and decryption of data of any kind, in which data are encrypted and decrypted using a random key, for ensuring the integrity and/or authenticity thereof, and/or for keeping secret the data contents. At the location of encryption, at least one permutation data element, one key control data element, and a random number are generated. Random keys are determined from at least one separate random reference data element and one random number. Clear data are bit-permuted in function of the permutation data and the random key, and encrypted and/or packet-permuted. The permutation data, key data and random data are added to the encrypted data in form of relative data. At the location of decryption, any data necessary for decryption are determined from the added data, and the encrypted data are decrypted.

The present invention relates to a method for encryption and decryption of data of any kind wherein data are encrypted and decrypted using a random key, for ensuring the integrity and/or authenticity thereof, and for keeping secret the data contents.

Symmetrical and asymmetrical encryption and decryption methods are known. Symmetrical encryption methods, also referred to as secret key methods, use keys that are known at the location of encryption and at the location of decryption. Symmetrical methods are cryptographic methods such as DES, triple DES, and AES. In the DES method, blocks of clear text having a length of 64 bits are subjected to a key independent input permutation. Each permuted 64 bit clear text block is then divided into a left hand side and a right hand side 32 bit block. A function is applied to the left 32 bit block, and the result thereof is exclusive or combined (XORed) with the right 32 bit block. The result of this combination becomes the new 32 bit block. The former left 32 bit block becomes the right 32 bit block. After 16 of such passes, the two 32 bit blocks are combined and subjected to a re-permutation. The function employed in the DES method uses, in each pass, a left block of 32 bits which is first permuted and extended to 48 bits. Then, an XOR combination is performed with a partial key having a length of 48 bits. The 48 bit block is divided into 8 blocks of 6 bits each which are transformed, via 8 substitution boxes, into eight output values of 4 bits each. The eight output values constitute the output value of the DES function with a length of 32 bits.

The DES method generates the partial key required for the 16 passes from a 56 bit key, by permutation and shift operations. Triple DES is based on a multiple application of the DES algorithm. The AES method by Rijndael is, like DES, a block chiffre. Like almost any block chiffre, Rijndael's AES encrypts data through a plurality of identical passes, applying a different partial key in each pass.

Asymmetrical encryption, also referred to as public key cryptography, is based on a public key and a first function for encryption, and on a private key and a second function for decryption. Both functions are related to each other in a defined manner.

The above known methods suffer from the key distribution problem. Each P2P communication requires preliminary exchange of a key.

From DE 101 04 307 A1, a method and an arrangement for data encryption are known wherein the key exchange problem is solved by transmitting the key in relative manner. Clear text data are encrypted in data encryption modules using a random key. In data interlace modules, additional information is interlaced into the data. Then, the encrypted and interlaced data are mixed by bit-byte permutation modules and packet permutation modules. The random key and other information are transmitted in relative form from the location of encryption to the location of decryption. The random key and the permutation data are generated in random generators of the transmitter. This solution has deficiencies with regard to the generation of real random numbers. Another disadvantage of this solution is the large complexity of bit-byte and packet permutation.

The method according to the invention is a symmetrical method.

The object of the invention is to provide a method which, in each new encryption operation, encrypts clear data with a random key newly generated at the location of encryption directly before encryption, which allows decryption of the chiffre data only to an authorized person independently from the location of encryption, and which generates the key data from random data of a plurality of independent random generators.

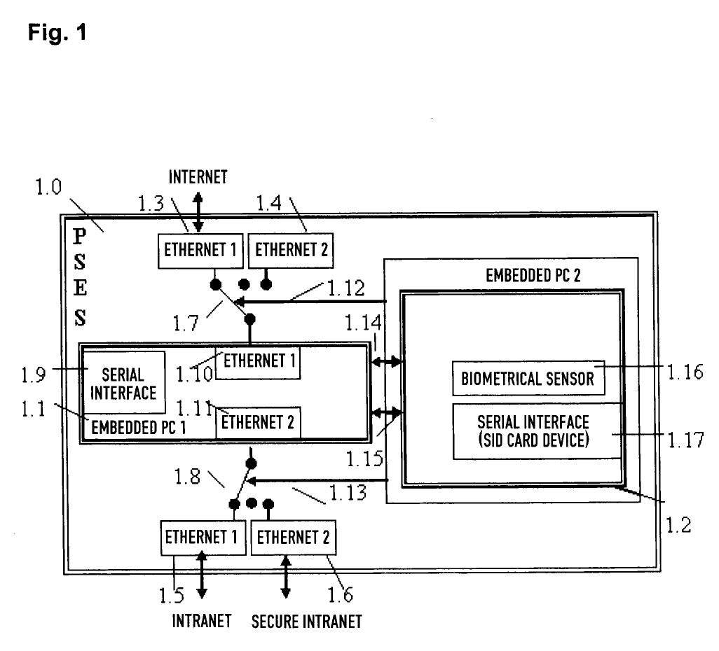

According to the invention, this object is achieved by the teachings set forth in the claims. The invention will now be described in detail with reference to FIGS. 1 to 4.

FIG. 1 exemplarily shows a unit 1.0 for implementing the inventive method. Unit 1.0 comprises a communication performing module 1.1, an encrypting and/or decrypting module 1.2, Ethernet interfaces 1.3, 1.4, 1.5, and 1.6, switches 1.7, 1.8. Module 1.1, embedded PC 1, comprises at least one serial interface 1.9, Ethernet interfaces 1.10, 1.11, and ports 1.14, 1.15. Module 1.2, embedded PC 2, comprises at least ports 1.14, 1.15, a biometrical sensor 1.16, and a serial interface 1.17. Module 1.2 switches switch 1.7 via port 1.12, and switches switch 1.8 via port 1.13. Unit 1.0 is connected to the internet via Ethernet interface 1.3. Ethernet interface 1.4 is provided for implementing redundant networks. Ethernet interface 1.5 is connected to a home PC, not shown. Unit 1.0 is in communication with a secure intranet via Ethernet interface 1.6. Modules 1.1 and 1.2 of unit 1.0 are interconnected via its separate ports 1.14 and 1.15. Module 1.1 provides encrypted and/or non-encrypted data to module 1.2 via separate port 1.14 and/or separate port 1.15. Module 1.2 provides decrypted and/or encrypted data to module 1.1 via separate port 1.15 and/or separate port 1.14. In module 1.2, at least one random reference data element is stored for randomly predefined time periods, in an unalterable and secret manner. For authentication purposes, module 1.2 is connected to a card device, not shown. A person gets authorized, e.g. by its fingerprint, in conjunction with its personal secure card, not shown. Module 1.2 authenticates the personal secure card.

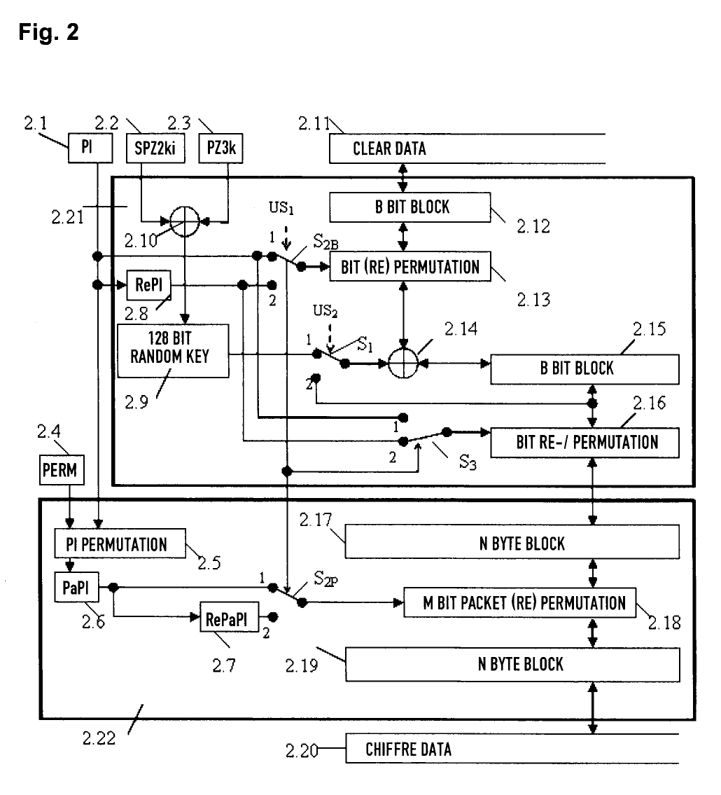

FIG. 2 shows a first embodiment of the inventive method. The figure illustrates a permutation data element 2.1 (PI), a separate random reference data element 2.2 (SPZ2ki), a random number 2.3 (PZ3k), another permutation data element 2.4 (PERM), a PI permutation module 2.5, a packet permutation data element 2.6 (PaPI), a re-packet permutation data element 2.7 (RePaPI), a re-permutation data element 2.8 (RePI), a random key data element 2.9, XOR combinations 2.10, 2.14, switches S₁, S_{2B}, S_{2P}, S₃, memory blocks 2.12. 2.15. 2.17, 2.19, permutation and re-permutation modules 2.13, 2.16, 2.18, clear data 2.11 and chiffre data 2.20. Encryption and decryption is performed in two stages, 2.21 and 2.22, as illustrated. Here, stage 2.21 includes bit based operations, and step 2.22 includes packet based operations.

Separate random reference data element 2.2 is read from the random reference data element, not shown, which is valid for a time period, by encrypting and decrypting module 1.2. The information about the reading position for the separate random reference data element, the permutation data element 2.1, random number 2.3, and permutation data element 2.4 are generated at the location of encryption in module 1.2 by a random generator of module 1.2, not shown. Permutation data element 2.1 comprises eight sub-permutation data having a length of 16 bytes each. Each byte of the 128 bytes indicates the position of a bit in the permuted or non-permuted 128 bit block (B bit block). The position of the byte in permutation data element 2.1 indicates the position of a bit in the non-permuted or permuted 128 bit block. Generation of the values of a permutation byte (PBj) is preferably performed by randomly drawing numbers from a sequence of numbers from 0 to 127. Each drawing operation can be a valid or an invalid drawing operation. Drawing of a number is valid and only valid, if the drawn number is not equal to the position index j of permutation byte PBj in the permutation data element PI={PB0,. . . PB127}. In case the drawing operation is valid, the drawn number is adopted at the position of the position index of the permutation byte in the permutation data element PI. In case the drawing operation is not valid, the drawn number is the same as the position index j of permutation byte PBj. It is then replaced in the sequence of numbers prior to the next drawing operation therefrom.

Permutation data element 2.4 has a word length of 24 bits. Every three bits indicate the position of a sub-permutation data element in packet permutation data element 2.6. The value of three bits designates the position of a sub-permutation data element in packet permutation data element 2.6, or of a sub-permutation data element in permutation data element 2.1. The position of three bits in the 24 bit permutation data element 2.4 indicates the position of a sub-permutation data element in permutation data element 2.4, or of a sub-permutation data element in packet permutation data element 2.6. The number generation for the three bits is performed in similar manner as described in the preceding paragraph.

Thus, packet permutation data element 2.6 comprises 128 bytes. Each byte of the 128 byte packet permutation data element 2.6 indicates the position of an M bit packet in the permuted or non-permuted N byte block. The position of the byte in the packet permutation data element 2.6 indicates the position of an M bit packet in the non-permuted or permuted N byte block.

For the selected exemplary embodiment is B=128, M=64, and N=1024.

The 128 bit random key 2.9 is determined from the separate 128 bit random reference data element 2.2 and the 128 bit random number 2.3 by XOR combination 2.10.

Clear data 2.11 are divided into blocks 2.12 of 128 bits. Each 128 bit block 2.12 is permuted bit-by-bit using permutation data element 2.1, by permutation and re-permutation module 2.13. Following bit permutation, the first bit-permuted block of clear data is XORed with the 128 bit random key 2.9. Following encryption of the first bit-permuted block, switch S₁ switches to position 2, by means of switching data element US₂, so that each subsequent bit-permuted block uses the encrypted bit-permuted clear data of the preceding block as a random key.

The encrypted bit-permuted clear data blocks are re-permuted bit-by-bit in re-/permutation module 2.16 and combined into blocks 2.17 of 1024 bytes each. Each 64 bit packet of a 1024 byte block 2.17 is permuted, packet-by-packet, in function of packet permutation data element 2.6, in M bit packet (re-) permutation module 2.18. All of the permuted 1024 byte blocks 2.19 then give the chiffre data 2.20. Decryption of chiffre data 2.20 is performed in reverse order of encryption. Permutations are substituted by re-permutations, and re-permutations are substituted by permutations. Switches S_{2B}, Sₑp then are in position 2, and switch S₃ is in position 1. Switching is performed with data element US_{I}.

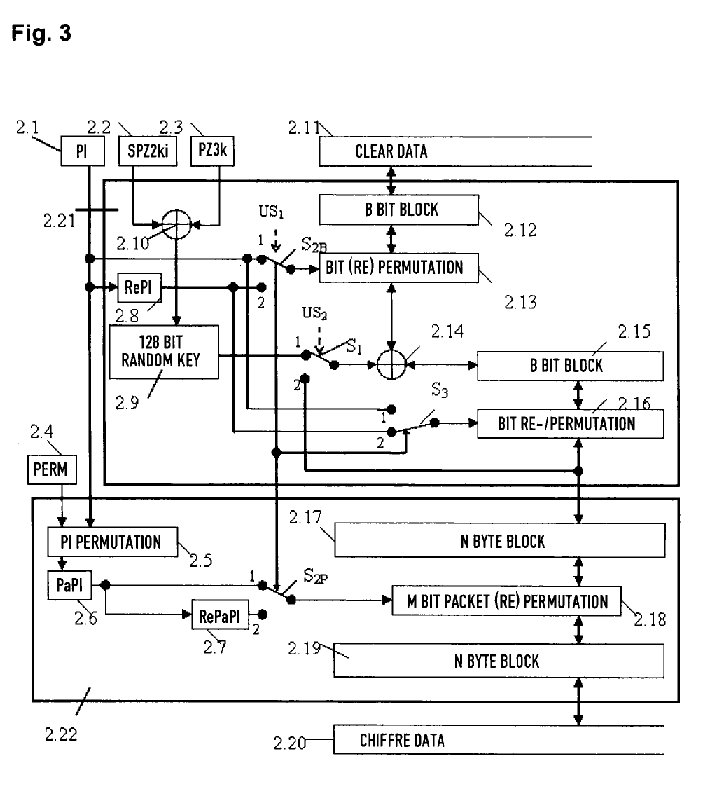

FIG. 3 shows a second embodiment of the inventive method. This embodiment is different from the first embodiment only in that the random key, from the second bit-permuted clear data block on, is not the preceding encrypted bit-permuted clear data block but the preceding re-permuted encrypted bit-permuted clear data block.

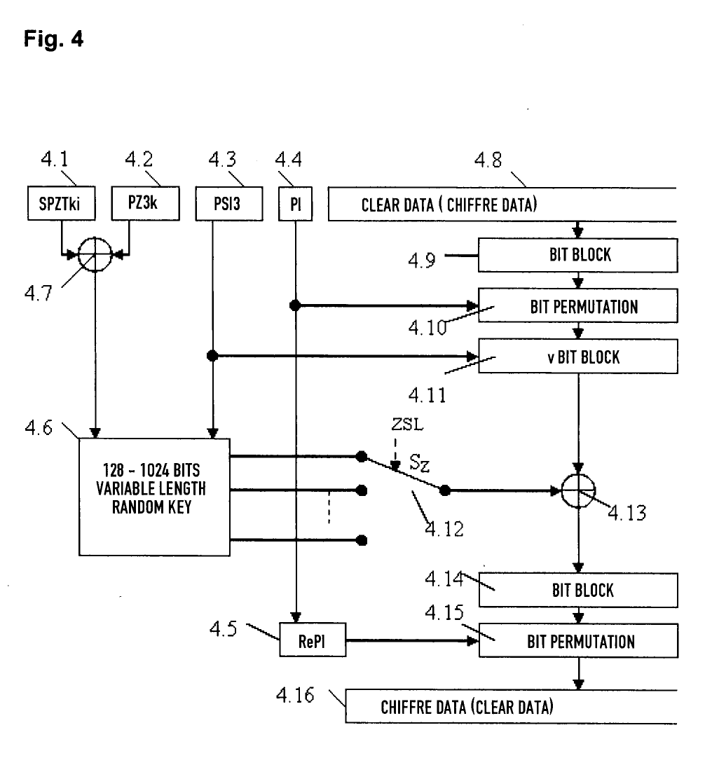

FIG. 4 shows a third embodiment of the inventive method. It illustrates a separate random reference data element 4.1 (SPZTki), a random number 4.2 (PZ3k), a key control data element 4.3 (PSI3), a permutation data element 4.4 (P1), a re-permutation data element 4.5 (RePI), a random key data element or a plurality of random key data 4.6, XOR combinations 4.7, 4.13, clear data 4.8, memory blocks 4.9, 4.11, 4.14, a bit permutation module 4.10, a switch 4.12, a re-permutation module 4.15, and chiffre data 4.16.

Key control data element 4.3 informs about the key lengths of the keys to be applied, the key repetition numbers, encryption type, and/or the reading position of the separate random reference data element with regard to the global random reference data element.

A key repetition number indicates the number of repeated applications of a key to clear data. Permutation data element 4.4 is similar to permutation data element 2.1 of the first and second embodiments of the method according to the invention. From permutation data element 4.4, re- permutation data element 4.5 is determined. Separate random reference data element 4.1 is read from the random reference data element, not shown, valid for a time period, by encrypting and decrypting module 1.2. Information about the reading position for the separate random reference data element, random number 4.2, key control data element 4.3, and permutation data element 4.4 are generated at the location of encryption in module 1.2, by a random generator of module 1.2, not shown. Each random key 4.6 used for a data encryption operation, is generated from the separate random reference data element and from at least one random number 4.2 having a length of 128 bits, by XOR combination. The length of the separate random reference data element can be the same or not the same as the length of the random number. If, in the XOR combination, the length of the separate random reference data element is not the same as that of the random number, the smaller quantity is applied repeatedly. If the sum of the length of all the keys used in data encryption is larger than the length of the separate random reference data element, a key data element is generated from the separate random reference data element and from at least one random number, with the length of the key data element being the same as the total length of all the keys used in one data encryption operation. Each key used in one data encryption operation is then retrieved from the key data element in function of key control data element 4.3.

In one data encryption operation, clear data are divided into bit blocks. Each bit block is subjected to a bit permutation. The bit-permuted clear data are combined into new variable bit blocks, with the length of a variable bit block 4.11 being the same as the length of the key. The bit-permuted clear data of the variable bit block are XORed with the random key selected by switch 4.12. The results are temporarily stored in bit block 4.14, subjected to re-permutation, and output as chiffre data 4.16. Decryption is performed in the same manner as encryption.

1. A method for access and communication based random encryption and decryption of data, comprising;
with at least one encrypting unit, subjecting the data to be encrypted to at least one block-by-block permutation wherein at least a portion of the permutation data is generated locally at the location of encryption in a random process,
with the at least one encrypting unit, encryptsing the data to be encrypted block-by-block using at least one random key which is generated from at least a portion of a global random reference data element provided in all of the units, and from at least one random number locally generated by said at least one encrypting unit,
with said at least one encrypting unit, adding the locally generated permutation data and the locally generated random number or locally generated random numbers to the encrypted data in form of relative data,
with at least one decrypting unit, at a location of decryption, retrieveing, prior to decryption, the permutation data and the random number or random numbers from the relative data, wherein all of the random keys are determined from thea global random reference data element provided at the location of decryption, and from the random number retrieved from the relative data, and
with said at least one decrypting unit, decrypting the data to be decrypted block-by-block using all of the random keys and using at least one re-permutation and/or permutation.

2. The method according to claim 1, wherein:
the locally added data are interlaced before being added, the data interlace information being a part of the global random reference data element,
the global random reference data element is only valid for a single time period, and/or
spatial data are determined from the global random reference data element, and/or
the relative data are determined with reference to said spatial data and said random reference data wherein one portion of the random reference data is a part of said global random reference data element, and another portion is a locally generated random number, and/or
said part of a global random reference data element provided in all of the units is a separate random reference data element which is only allocated to authenticated units, and/or
the at least one encrypting unit informs the at least one decrypting unit about reading position for the separate random data element in the global random reference data element, and/or
said information is given in form of relative data.

3. The method according to claim 1, wherein:
said data to be encrypted are permuted bit-by-bit and encrypted in blocks of predefined length, wherein the random key for a first block is formed from a portion of said global random number and from a locally generated random number, and any further key for subsequent blocks is formed from the encrypted data of a preceding block,
a number of encrypted blocks are combined into larger blocks, and each larger block is subjected to a packet permutation, and
decryption steps are performed in inverse order to encryption, with re-permutations being performed instead of permutations, and permutations being performed instead of re-permutations.

4. The method according to claim 3, wherein:
the random keys for all the blocks except that the random key for the first block are formed by re-permutation of the encrypted data of the preceding block, or
for all the blocks following the first block, the encrypted data of the preceding block are used as a random key, and
the data encrypted using the random keys are subjected to a re-permutation block-by-block.

5. The method according to claim 1, wherein:
said data to be encrypted are permuted bit-by-bit in blocks of predefined length,
said permuted data are encrypted using at least one random key of variable length,
said encrypted data are re-permuted within said blocks of predefined length, and
decryption is performed in the same order and using the same operations as encryption.

6. The method according to claim 1, wherein:
said data to be encrypted are permuted bit-by-bit in blocks of predefined length,
said permuted data are encrypted using more than one random key wherein a random key is repeatedly applied in function of at least one key repetition number before the a next random key is applied,
said encrypted data are re-permuted in said blocks of predefined length,
all of the key repetition numbers are determined in a random process and are added to the encrypted data in form of at least one relative data element, and
decryption is performed in the same order and using the same operations as encryption.

7. The method according to claim 1, wherein:
the random encryption operations are exclusive or (XOR) combinations performed bit-by-bit, and/or
there is more than one permutation data element, and/or
a permutation data element comprises a plurality of sub-permutation data, and each sub-permutation data element comprises a plurality of permutation bytes,
each sub-permutation data element indicates the new position of a predefined number of bits in the permuted block, and
the bit position in the permuted block is defined by the position of the permutation byte in the permutation data element, and bit position in the non-permuted block is defined by value of the permutation byte, or the bit position in the non-permuted block is defined by position of the permutation byte in the permutation data element, and the bit position in the permuted block is defined by the value of the permutation byte.

8. The method according to claim 3, wherein the packet permutation data are generated from the bit permutation data by permutation, wherein the values and the position of the permutation byte in the permuted permutation data element indicate the positions of the bit packets in the permuted and non-permuted block.

9. The method according to claim 7, wherein:
the value of a permutation byte is determined by randomly drawing numbers from a sequence of numbers of a predefined length, while differentiating between a valid and invalid drawing operation,
in a valid drawing operation the drawn value is not the same as the position index of the permutation byte in the permutation data element, and the drawn value is adopted in place of said position index of the permutation byte in the permutation data element, and
in an invalid drawing operation the drawn value is the same as the position index of the permutation byte in the permutation data element, and the drawn value is replaced in the sequence of numbers.

10. The method according to claim 2, wherein:
any random key is generated by bit-by-bit XOR combining a separate random reference data element and a random number, said separate random reference data element being a part of a global random reference data element provided in all of the units, and/or
said random number has a predefined length, and/or
the length of said separate random reference data element is the same or is smaller than or larger than the total lengths of all the keys that are to be used and are used in a data encryption operation, wherein, if the length is larger, the excessive length of the random reference data element is not used, and if the length is smaller, a key data element with a length equal to the total length of all the keys used in a data encryption operation is defined from the separate random reference data element and at least one random number, and/or
said key data element is determined by XOR combining at least a portion of the separate random reference data element or the separate random reference data element and at least a portion of at least one random number, and/or
any key used in a data encryption operation is taken from the key data element, and/or
the length of said separate random reference data element is the same or not the same as the length of said random number, and/or
if the lengths are not the same, the smaller quantity is repeatedly applied in the XOR combination, and
if the length of the random number is smaller, a random data element with the same length as that of the separate random reference data element is formed from the random number and at least another random number, and/or
said random data element is determined by bit-by-bit XOR combining said random number and at least a part or more than a part of said further random number, and/or
said separate random reference data element and said random number or random data element are considered as position vectors of a predefined space, which are bit-by-bit XOR combined for each coordinate, the dimension of the coordinates of the position vectors being determined by the spatial dimensions of the predefined space, and
if the dimension of a vector coordinate is smaller, the value of the coordinate is repeatedly used in the calculation of the XOR combination, or if the dimension of a vector coordinate is larger, only that part of the vector coordinate is used that overlies the spatial coordinate.

11. The method according to claim 1, wherein:
the random numbers and/or random reference data used for generating the key data element or random key are generated from partial random data which, arranged in a sequence, form the random number or the respective random reference data element,
two consecutive partial random data have a Hamming distance of at least one, and
the length of the partial random data element is the same as the length of the data to be encrypted.

12. The method according to claim 1, wherein:
encryption and decryption of the data is performed in conjunction with authentication and authentification, and
authentication and authentification required for performing decryption is performed using at least one data element identifying a person and/or a unit, and/or address data, and/or devices data, which are added to the encrypted data in form of relative data.

13. The method according to claim 8, wherein:
the value of a permutation byte is determined by randomly drawing numbers from a sequence of numbers of a predefined length, while differentiating between a valid and invalid drawing operation,
in a valid drawing operation the drawn value is not the same as a position index of the permutation byte in the permutation data element, and the drawn value is adopted in place of said position index of the permutation byte in the permutation data element, and
in an invalid drawing operation the drawn value is the same as the position index of the permutation byte in the permutation data element, and the drawn value is replaced in the sequence of numbers.

14. The method according to claim 6, wherein:
any random key is generated by bit-by-bit XOR combining a separate random reference data element and a random number, said separate random reference data element being a part of a global random reference data element provided in all of the units, and/or
said random number has a predefined length, and/or
the length of said separate random reference data element is the same or is smaller than or larger than the total lengths of all the keys that are to be used and are used in a data encryption operation, wherein, if the length is larger, the excessive length of the random reference data element is not used, and if the length is smaller, a key data element with a length equal to the total length of all the keys used in a data encryption operation is defined from the separate random reference data element and at least one random number, and/or
said key data element is determined by XOR combining at least a portion of the separate random reference data element or the separate random reference data element and at least a portion of at least one random number, and/or
any key used in a data encryption operation is taken from the key data element, and/or
the length of said separate random reference data element is the same or not the same as the length of said random number, and/or
if the lengths are not the same, the smaller quantity is repeatedly applied in the XOR combination, and
if the length of the random number is smaller, a random data element with the same length as that of the separate random reference data element is formed from the random number and at least another random number, and/or
said random data element is determined by bit-by-bit XOR combining said random number and at least a part or more than a part of said further random number, and/or
said separate random reference data element and said random number or random data element are considered as position vectors of a predefined space, which are bit-by-bit XOR combined for each coordinate, the dimension of the coordinates of the position vectors being determined by the spatial dimensions of the predefined space, and
if the dimension of a vector coordinate is smaller, the value of the coordinate is repeatedly used in the calculation of the XOR combination, or if the dimension of a vector coordinate is larger, only that part of the vector coordinate is used that overlies the spatial coordinate.
